(19) United States
(12) Patent Application Publication
(10) Pub. No.: US 2016/0293932 A1
(43) Pub. Date: Oct. 6, 2016

(54) SYNTHETIC METHODS FOR TRANSITION METAL COORDINATION COMPOUNDS

(71) Applicant: Alveo Energy, Inc., Palo Alto, CA (US)

(72) Inventors: Shahrokh Motallebi, Los Gatos, CA (US); Olivia Nathalie Risset, Mountain View, CA (US); Colin Deane Wessells, Palo Alto, CA (US)

(73) Assignee: Alveo Energy, Inc., Palo Alto, CA (US)

(21) Appl. No.: 15/085,881

(22) Filed: Mar. 30, 2016

Related U.S. Application Data
(60) Provisional application No. 62/140,430, filed on Mar. 30, 2015.

(51) Int. Cl. H01M 4/04; H01M 4/58; C01C 3/12

(52) U.S. Cl. CPC H01M 4/049; C01C 3/12; H01M 4/58; C01P 2006/40; C01P 2004/64; C01P 2004/62

(57) ABSTRACT

A system and method for controlling particle morphology of transition metal coordination compounds (TMCC). Synthesis of TMCC using one of several chelating agents having carboxylate chemical groups. These carboxylate groups bind to copper during the synthesis of the CuHCF TMCC materials, resulting in controlled particle growth, rather than rapid formation of many small nanoparticles as is the case without any chelating agent present. The materials produced using chelating agents of these embodiments such as these are composed of larger particles, making them easier to process into battery electrodes via standard methods such as slurry mixing and coating. The resulting electrodes retain the good electrochemical cycling performance of the control material synthesized without a chelating agent.

### CROSS REFERENCE TO RELATED APPLICATIONS

This application claims benefit of U.S. patent application Ser. No. 62/140,430 filed 30 Mar. 2015, the contents of which are hereby expressly incorporated by reference thereto in its entirety for all purposes.

### STATEMENT REGARDING FEDERALLY SPONSORED RESEARCH OR DEVELOPMENT

This invention was made with government support under ARPA-E Award No. DE-AR00000300 with Alveo Energy, Inc., awarded by DOE. The government has certain rights in the invention.

### FIELD OF THE INVENTION

The present invention relates generally to particle morphology control, and more specifically, but not exclusively, to agents, for example, chelating agents, as a method to control a particle morphology of a transition metal coordination compound such as may be used in an electrochemical device, such as a battery electrode material.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Transition metal coordination compounds (TMCC) are desirable for use as battery electrode materials because they have long cycle life and high rate capability. Previous syntheses of these materials have resulted in small nanoparticles that are difficult to process into battery electrodes.

What is needed is a system and method for controlling particle morphology of TMCC.

### BRIEF SUMMARY OF THE INVENTION

Disclosed is a system and method for controlling particle morphology of Transition metal coordination compounds (TMCC). The following summary of the invention is provided to facilitate an understanding of some of technical features related to controlling a particle morphology of TMCC in general, and controlling a particle morphology of copper hexacyanoferrate (CuHCF), a well-known TMCC, and is not intended to be a full description of the present invention. A full appreciation of the various aspects of the invention can be gained by taking the entire specification, claims, drawings, and abstract as a whole. The present invention is applicable to other TMCC in addition to CuHCF, and to controlling particle morphology of a TMCC for uses other than as a battery electrode material.

Some embodiments of the present invention include a use of chelating agents to control a morphology of copper hexacyanoferrate (CuHCF), a well-known TMCC that has properties characteristic to many hexacyanoferrate-based TMCC materials.

Some embodiments include use of one of several chelating agents having carboxylate chemical groups. These carboxylate groups bind to copper during the synthesis of the CuHCF TMCC materials, resulting in controlled particle growth, rather than rapid formation of many small nanoparticles as is the case without any chelating agent present.

The materials produced using chelating agents such as those of these embodiments are composed of larger particles, making them easier to process into battery electrodes via standard methods such as slurry mixing and coating. The resulting electrodes retain the good electrochemical cycling performance of the control material synthesized without a chelating agent.

A method for producing a transition metal coordination compound (TMCC), including: reacting an alkali salt of a coordination complex with a salt of a transition metal in a reaction solution while the reaction solution concurrently includes a reducing agent.

A method for producing a transition metal coordination compound (TMCC) that includes reacting an alkali salt of a coordination complex with a salt of a transition metal in a reaction solution which produces a first set of particles of the TMCC having a first characteristic particle size, an improvement including a reacting material with the reaction solution during the reacting step which produces a second set of particles of the TMCC having a second characteristic particle size greater than the first characteristic particle size.

A material comprising: a transition metal coordination compound (TMCC) including a plurality of particles having a first particle size within a range of 50 nm-500 nm and including a first electrochemical cycling performance about equal to a second electrochemical cycling performance of the TMCC having a second particle size about one-fifth that of the first particle size.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a scanning electron microscopy (SEM) of Example 1;

FIG. 2 illustrates a cycle life of Example 1;

FIG. 3 illustrates a voltage profile of Example 1;

FIG. 4 illustrates an SEM of Example 2;

FIG. 5 illustrates a cycle life of Example 2;

FIG. 6 illustrates a voltage profile of Example 2;

FIG. 7 illustrates an SEM of Example 3;

FIG. 8 illustrates an SEM of Example 4;

FIG. 9 illustrates an SEM of Example 5; and

FIG. 10 illustrates an SEM of Example 6 (control).

### DETAILED DESCRIPTION OF THE INVENTION

Embodiments of the present invention provide a system and method for controlling particle morphology of TMCC. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

Definitions

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

As used herein, the term “size” refers to a characteristic dimension of an object. Thus, for example, a size of an object that is spherical can refer to a diameter of the object. In the case of an object that is non-spherical, a size of the non-spherical object can refer to a diameter of a corresponding spherical object, where the corresponding spherical object exhibits or has a particular set of derivable or measurable properties that are substantially the same as those of the non-spherical object. Thus, for example, a size of a non-spherical object can refer to a diameter of a corresponding spherical object that exhibits light scattering or other properties that are substantially the same as those of the non-spherical object. Alternatively, or in conjunction, a size of a non-spherical object can refer to an average of various orthogonal dimensions of the object. Thus, for example, a size of an object that is a spheroidal can refer to an average of a major axis and a minor axis of the object. When referring to a set of objects as having a particular size, it is contemplated that the objects can have a distribution of sizes around the particular size. Thus, as used herein, a size of a set of objects can refer to a typical size of a distribution of sizes, such as an average size, a median size, or a peak size.

Some embodiments of the present invention include a use of chelating agents to control a morphology of copper hexacyanoferrate (CuHCF), a well-known TMCC that has properties characteristic to many hexacyanoferrate-based TMCC materials.

Some embodiments include use of one of several chelating agents having carboxylate chemical groups. These carboxylate groups bind to copper during the synthesis of the CuHCF TMCC materials, resulting in controlled particle growth, rather than rapid formation of many small nanoparticles as is the case without any chelating agent present.

The materials produced using chelating agents of these embodiments are composed of larger particles, making them easier to process into battery electrodes via standard methods such as slurry mixing and coating. The resulting electrodes retain the good electrochemical cycling performance of the control material synthesized without a chelating agent.

In some embodiments, a transition metal may include an element having an atom with a partially filled d sub-shell and/or may include an atom which can give rise to a cation with a partially filled d sub-shell.

In some embodiments, an aqueous solution is used. For some embodiments, the term aqueous solution means a solution having water as a solvent, and in other embodiments, water is a majority solvent.

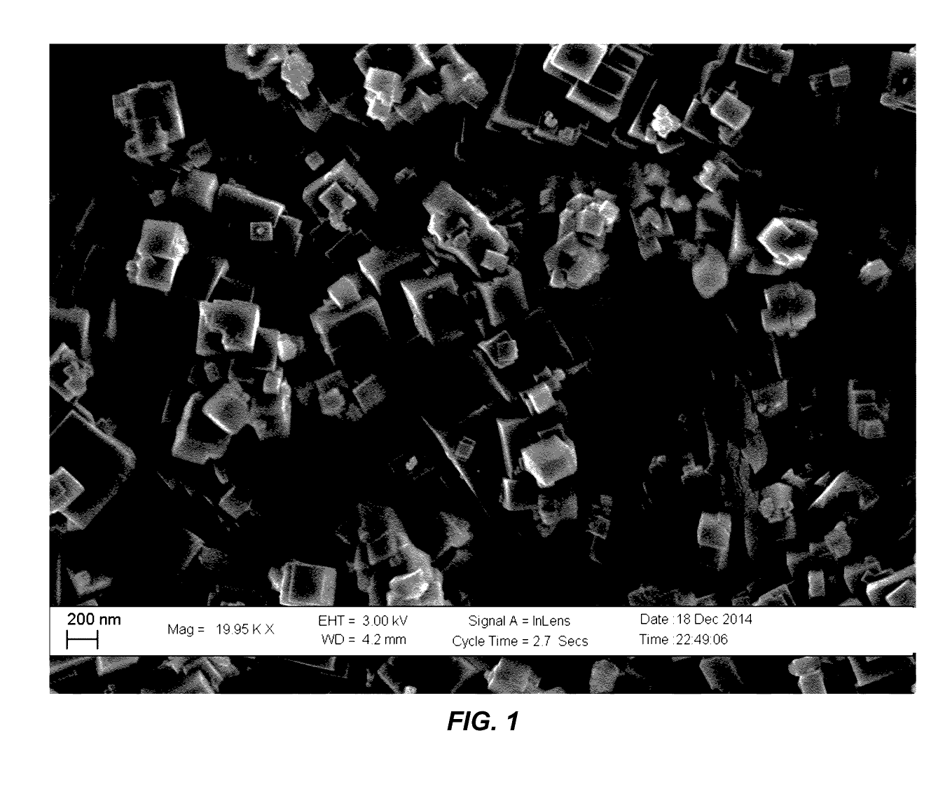

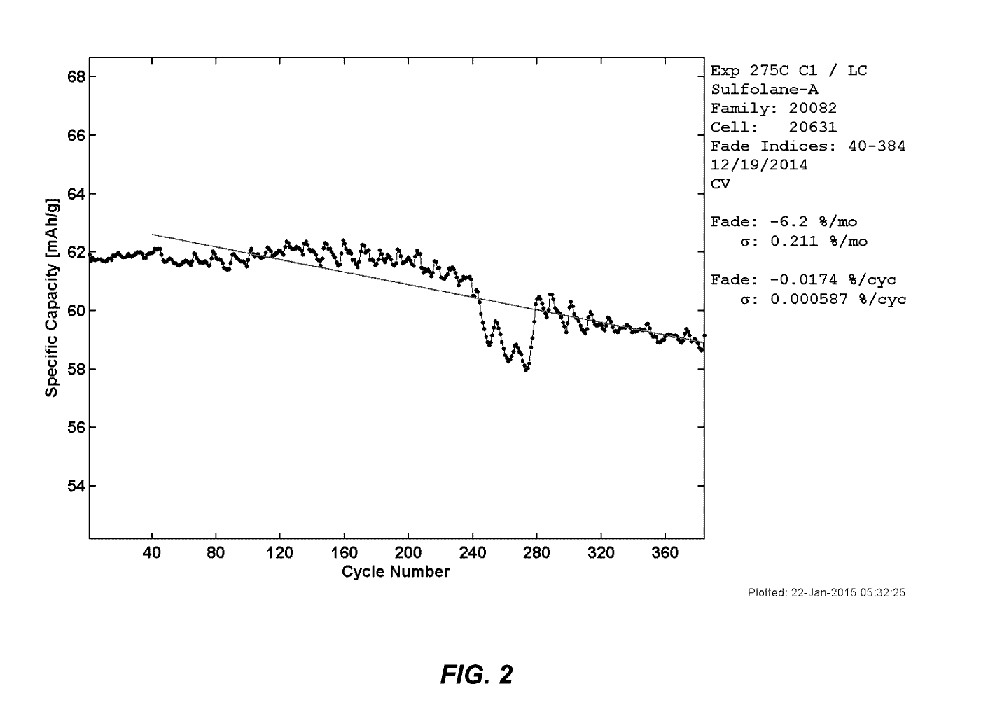

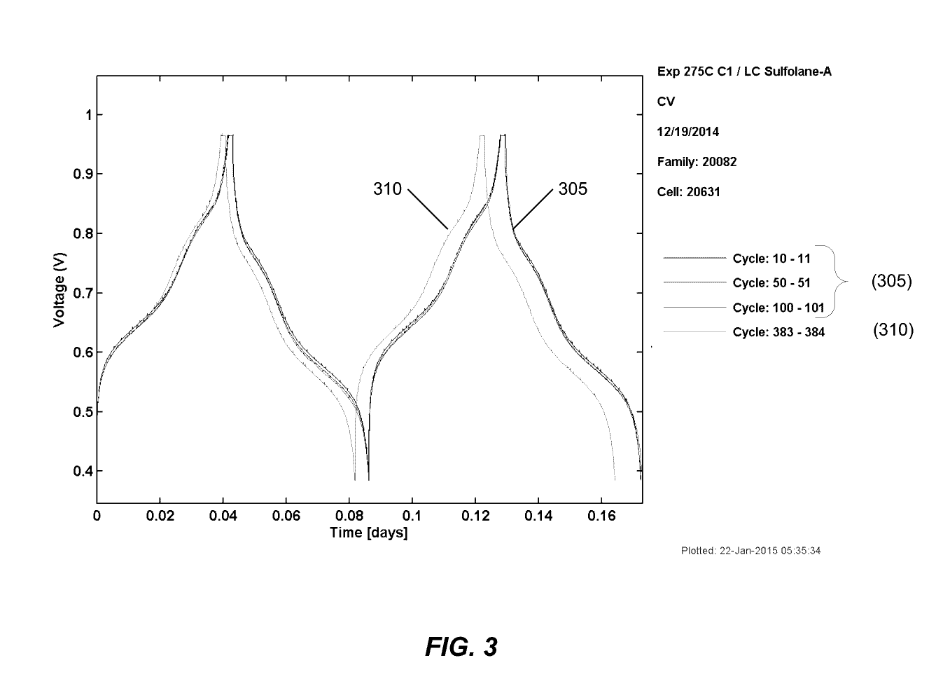

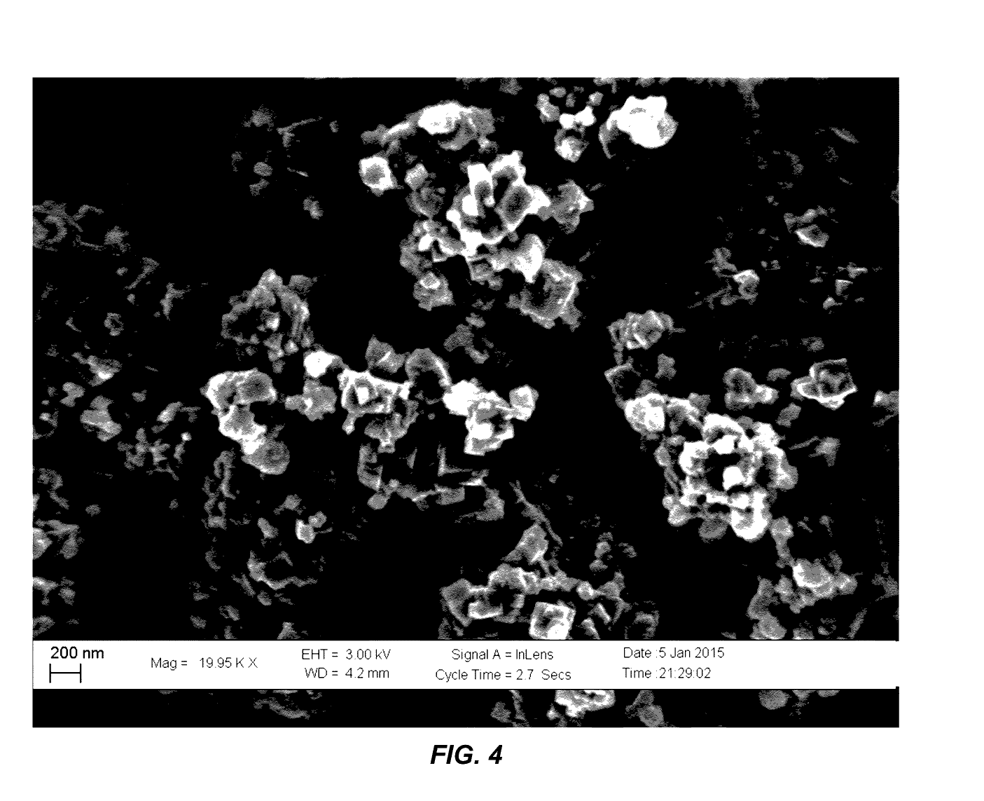

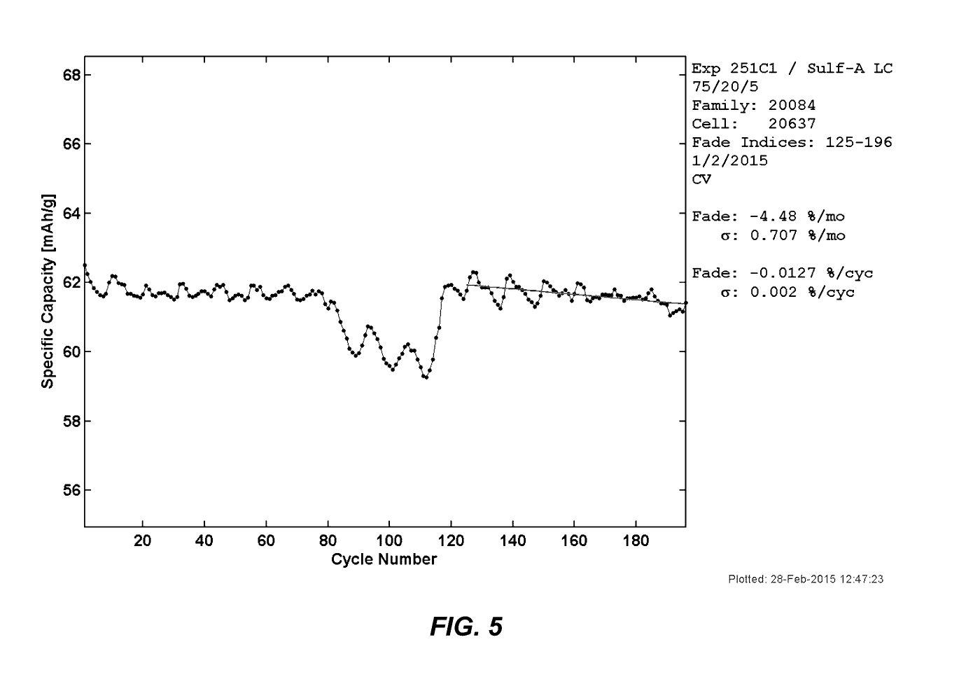

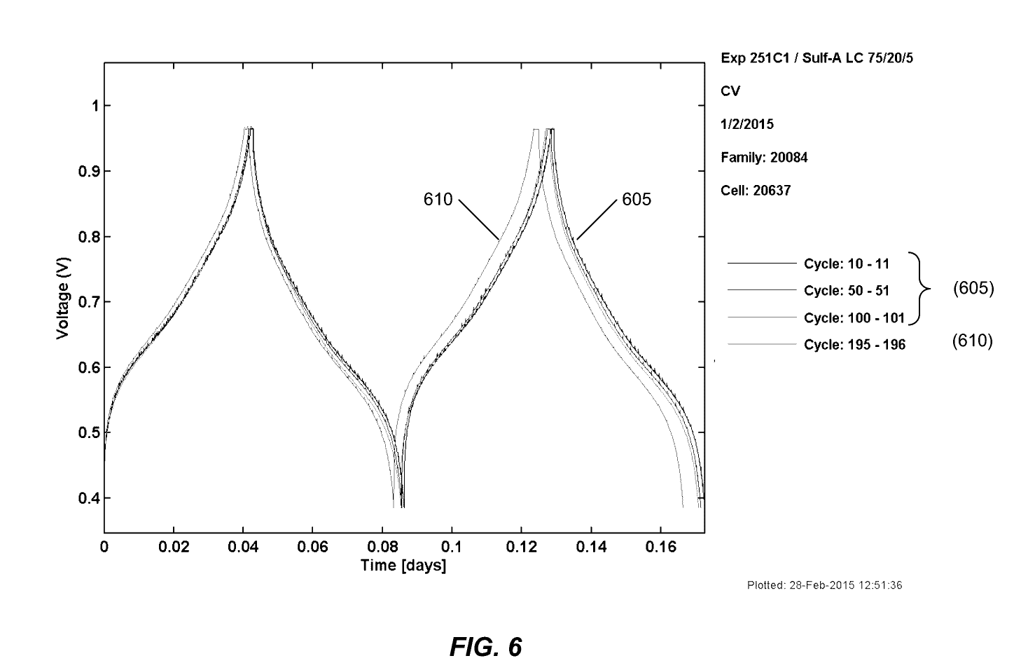

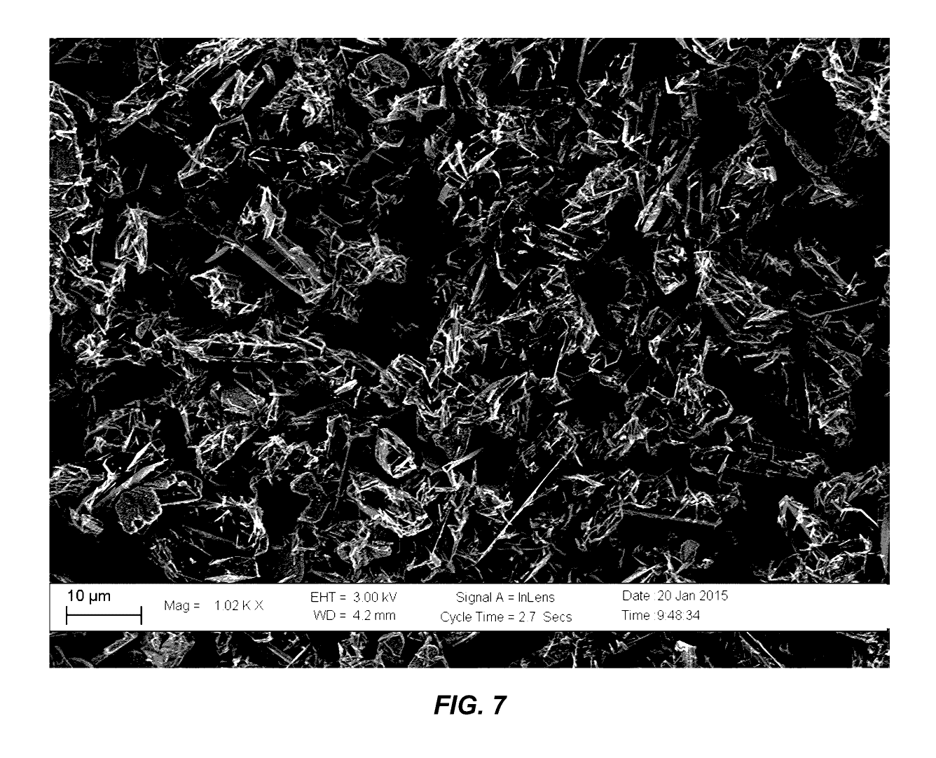

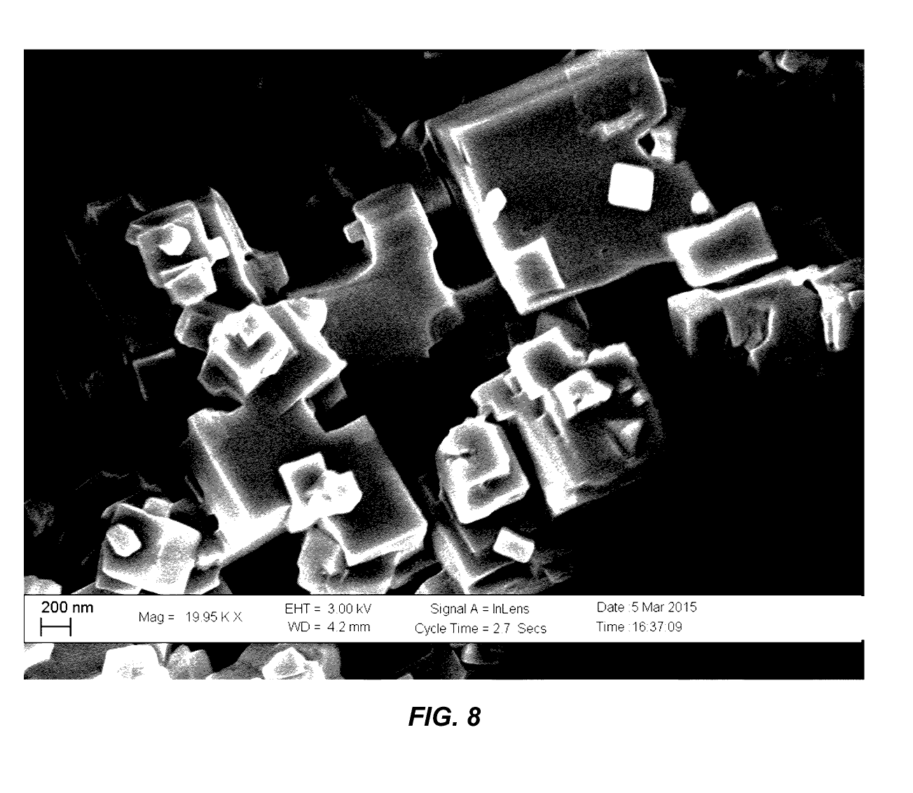

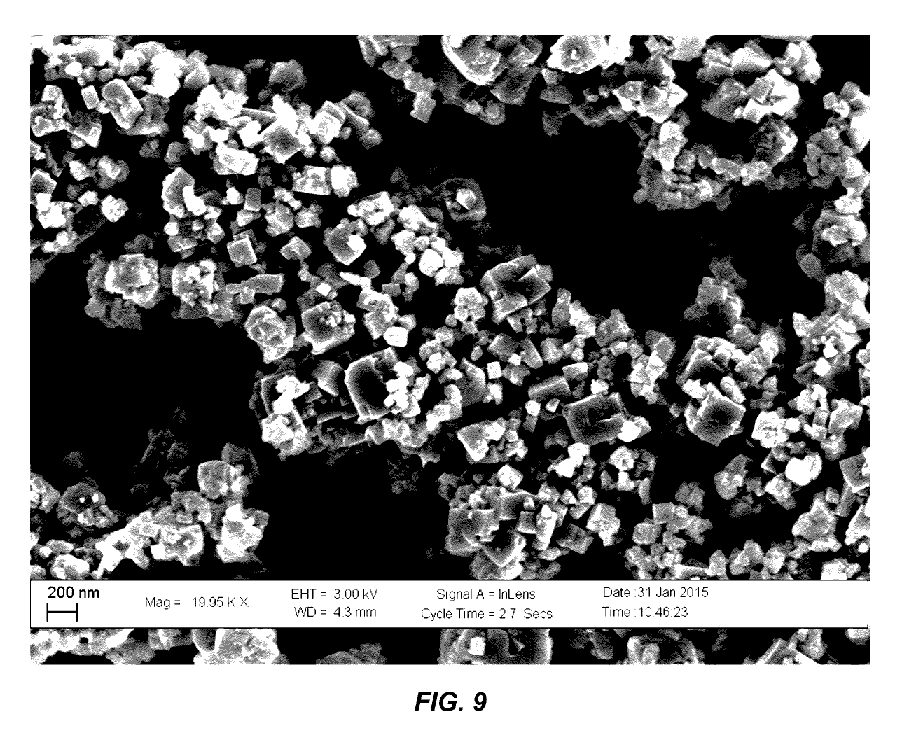

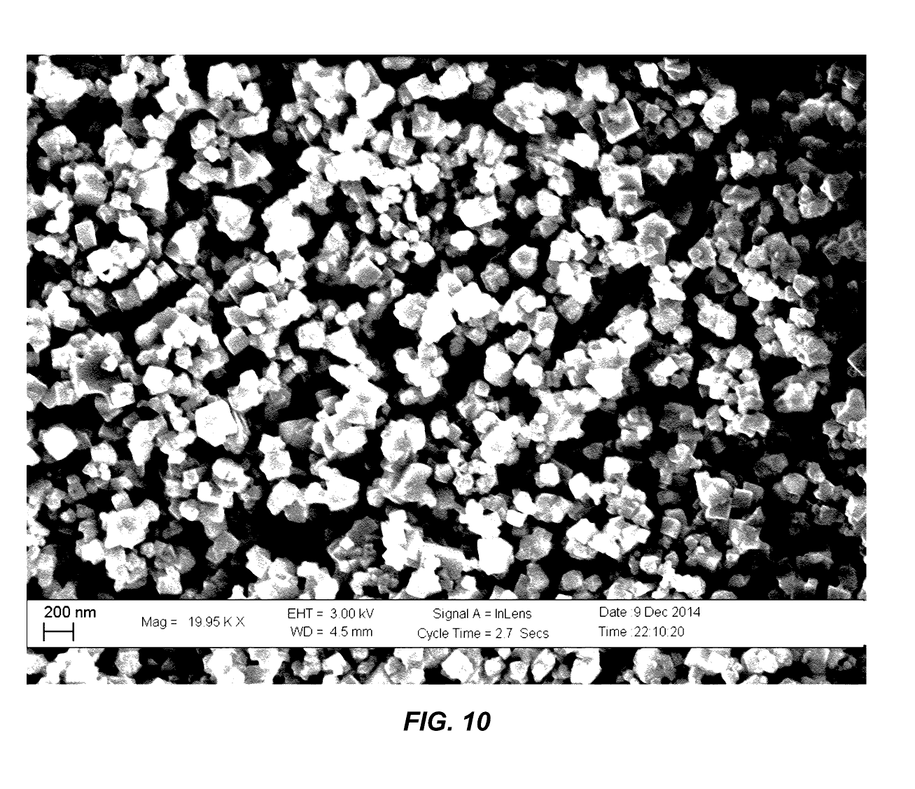

FIG. 1 illustrates a scanning electron microscopy (SEM) of Example 1; FIG. 2 illustrates a cycle life of Example 1; FIG. 3 illustrates a voltage profile of Example 1; FIG. 4 illustrates an SEM of Example 2; FIG. 5 illustrates a cycle life of Example 2; FIG. 6 illustrates a voltage profile of Example 2; FIG. 7 illustrates an SEM of Example 3; FIG. 8 illustrates an SEM of Example 4; FIG. 9 illustrates an SEM of Example 5; and FIG. 10 illustrates an SEM of Example 6 (control).

### EXAMPLES

Example 1: (Exp. 275C): In a 500 ml jacketed reactor equipped with a mechanical stirrer, water (50 g) and sodium acetate trihydrate (30 g) were added and the resulting solution is stirred at 300 r.p.m at 70 degree Celsius.

To this mixture, a solution of copper sulfate pentahydrate (7.0 g) in water (20 g) and a solution of sodium ferricyanide (6.7 g) in water (20 g) are simultaneously added dropwise over a period of 50 minutes. Once the addition completed, the resulting mixture was stirred for another 15 minutes and then cooled to room temperature.

The mixture was then filtered and the powder was washed with water (3×100 ml) and then with methanol (MeOH, 75 ml) to yield a brown powder. This powder was then dried under reduced pressure at 80 degree Celsius for 24 h. (See FIG. 1 illustrates a scanning electron microscopy (SEM) of Example 1; FIG. 2 illustrates a cycle life of Example 1; and FIG. 3 illustrates a voltage profile of Example 1.)

Example 2: (Exp. 286C): In a 500 ml jacketed reactor equipped with a mechanical stirrer, water (50 g) and sodium gluconate (5.0 g) were added and the resulting solution is stirred at 300 r.p.m at 70 degree Celsius.

To this mixture, a solution of copper sulfate pentahydrate (7.0 g) in water (23 g) and a solution of sodium ferricyanide (6.26 g) in water (24 g) are simultaneously added dropwise over a period of 50 minutes. Once the addition completed, the resulting mixture was stirred for another 5 minutes and then cooled to room temperature.

The mixture was then filtered and the powder was washed with water (3×100 ml) and then with MeOH (50 ml) to yield a purple powder. This powder was then dried under reduced pressure at 80 degree Celsius for 24 h. (See FIG. 4 illustrates a scanning electron microscopy (SEM) of Example 2; FIG. 5 illustrates a cycle life of Example 2; and FIG. 6 illustrates a voltage profile of Example 2.)

Example 3: (Exp. 301C): In a 500 ml jacketed reactor equipped with a mechanical stirrer, water (60 g) and potassium acetate (36 g) were added and the resulting solution is stirred at 300 r.p.m at 70 degree Celsius.

To this mixture, a solution of copper sulfate pentahydrate (9.0 g) in water (31 g) and a solution of potassium ferricyanide (6.9 g) in water (33 g) are simultaneously added dropwise over a period of 60 minutes. Once the addition completed, the resulting mixture was stirred for another 30 minutes and then cooled to room temperature.

The mixture was then filtered and the powder was washed with water (3×100 ml) and then with MeOH (75 ml) to yield a brown powder. This powder was then dried under reduced pressure at 80 degree Celsius for 24 h. (See FIG. 7.)

Example 4: (Exp. 320C): In a 1 L jacketed reactor equipped with a mechanical stirrer, water (360 g) and sodium formate (29.4 g) were added and the resulting solution is stirred at 310 r.p.m at 70 degree Celsius.

To this mixture, a solution of copper sulfate pentahydrate (54.0 g) in water (185 g) and a solution of potassium ferricyanide (41.4 g) in water (200 g) are simultaneously added dropwise over a period of 140 minutes. Once the addition completed, the resulting mixture was stirred for another 20 minutes and then cooled to room temperature.

The mixture was then filtered and the powder was washed with water (3×600 ml) and then with MeOH (300 ml) to yield a brown powder. This powder was then dried under reduced pressure at 80 degree Celsius for 24 h. (See FIG. 8.)

Example 5: (Exp. C-19): In a 500 mL jacketed reactor equipped with a mechanical stirrer, water (60 g) and sodium citrate (10.6 g) were added and the resulting solution is stirred at 310 r.p.m at 70 degree Celsius.

To this mixture, a solution of copper sulfate pentahydrate (9.0 g) in water (31 g) and a solution of potassium ferricyanide (6.9 g) in water (33 g) are simultaneously added dropwise over a period of 65 minutes. Once the addition completed, the resulting mixture was stirred for another 60 minutes and then cooled to room temperature.

The mixture was then filtered and the powder was washed with water (3×250 ml) and then with MeOH (50 ml) to yield a purple powder. This powder was then dried under reduced pressure at 80 degree Celsius for 24 h. (See FIG. 9.)

Example 6 (Control): (Exp. 251C): In a 500 mL jacketed reactor equipped with a mechanical stirrer, water (50 g) was added and the solution is stirred at 310 rpm at 70 degree Celsius.

To this mixture, a solution of copper sulfate pentahydrate (7.0 g) in water (20 g) and a solution of sodium ferricyanide (6.7 g) in water (20 g) are simultaneously added dropwise over a period of 50 minutes. Once the addition completed, the resulting mixture was stirred for another 15 minutes and then cooled to room temperature.

The mixture was then filtered and the powder was washed with water (3×100 mL) and then with MeOH (50 mL) to yield a brown powder. This powder was the dried under reduced pressure at 80 degree Celsius for 24 h. (See FIG. 10.)

The system and methods above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A method for producing a transition metal coordination compound (TMCC), comprising:
reacting an alkali salt of a coordination complex with a salt of a transition metal in a reaction solution while said reaction solution concurrently includes a reducing agent.

2. The producing method of claim 1 wherein a first volume includes said reaction solution, wherein a second volume includes a solution of said salt of said transition metal, and wherein a third volume includes a solution of said alkali salt of said coordination complex, and wherein said reacting includes adding said second volume into said first volume as said third volume is added into said first volume.

3. The producing method of claim 2 wherein said reaction solution includes an aqueous solution including said reducing agent at a temperature range between 25 C-100 C.

4. The producing method of claim 1 wherein said salt of said coordination complex includes one or more coordination complex salts each selected from the group consisting of an alkali salt of hexacyanoferrate, an alkali salt of hexacyanocobaltate, an alkali salt of hexacyanovanadate, an alkali salt of hexacyanotitanate, an alkali salt of hexacyanochromate and an alkali salt of hexacyanonickelate, and combinations thereof.

5. The producing method of claim 2 wherein said salt of said coordination complex includes one or more coordination complex salts each selected from the group consisting of an alkali salt of hexacyanoferrate, an alkali salt of hexacyanocobaltate, an alkali salt of hexacyanovanadate, an alkali salt of hexacyanotitanate, an alkali salt of hexacyanochromate and an alkali salt of hexacyanonickelate, and combinations thereof.

6. The producing method of claim 3 wherein said salt of said coordination complex includes one or more coordination complex salts each selected from the group consisting of an alkali salt of hexacyanoferrate, an alkali salt of hexacyanocobaltate, an alkali salt of hexacyanovanadate, an alkali salt of hexacyanotitanate, an alkali salt of hexacyanochromate and an alkali salt of hexacyanonickelate, and combinations thereof.

7. The producing method of claim 1 wherein said salt of said transition metal includes one or more transition metal salts each selected from the group consisting of an alkali salts of a transition metal and combinations thereof.

8. The producing method of claim 2 wherein said salt of said transition metal includes one or more transition metal salts each selected from the group consisting of an alkali salts of a transition metal and combinations thereof.

9. The producing method of claim 3 wherein said salt of said transition metal includes one or more transition metal salts each selected from the group consisting of an alkali salts of a transition metal and combinations thereof.

10. The producing method of claim 4 wherein said salt of said transition metal includes one or more transition metal salts each selected from the group consisting of an alkali salts of a transition metal and combinations thereof.

11. The producing method of claim 5 wherein said salt of said transition metal includes one or more transition metal salts each selected from the group consisting of an alkali salts of a transition metal and combinations thereof.

12. The producing method of claim 6 wherein said salt of said transition metal includes one or more transition metal salts each selected from the group consisting of an alkali salts of a transition metal and combinations thereof.

13. The producing method of claim 1 wherein said reducing agent includes one or more components each selected from the group consisting of formic acid, acetic acid, gluconic acid, malic acid, citric acid, homo citric acid, succinic acid, lactic acid, malonic acid, aspartic acid, 3,4-dihydroxybenzoic acid, 2,3-dihydroxybenzoic acid, tartaric acid, salicylic acid, glutamic acid, oxalic acid, 2,3-Di mercapto-1-propane sulfonic acid, meso-2,3-di mercapto succinic acid, glycine, alanine, imino di acetic acid, EDTA (ethylene diamine tetra-acetic acid), EGTA ethylene glycol-bis(2-amino ethyl ether)-N,N,N′,N′-tetra acetic acid), EDDS (ethylene di amine-N,N′-di succinic acid), NTA (nitrilo-tri-acetic acid), DTPA (diethyl triamine penta-acetic acid), PDTA (1,3-propylene diamine penta-acetic acid), MGDA (methyl glycine diacetic acid), β-ADA (β-alanine diacetic acid), HEIDA (N-(2-hydroxyethyl)imino diacetic acid), DHEG (N,N-bis(2-hydroxyethyl)glycine), HEDTA (hydroxy ethyl-ethylene diamine tri-acetic acid), quadrol (N,N,N′,N′-tetrakis-2-hydroxyisopropyl- ethylendiamine), DTPMP (diethylene triaminopenta (methylene phosphonic acid)), EDTMP (ethylene diaminotetra(methylene phosphonic acid)), HDTMP (hexamethylene diaminotetra (methylene phosphonic acid)), ATMP (aminotrimethylene phosphonic acid), HEDP (hydroxyethane dimethylene phosphonic acid) and PBTC (2-butane phosphate 1,2,4-tricarboxylic acid), phosphoric acid, pyrophosphoric acid, and combinations thereof.

14. The producing method of claim 3 wherein said reducing agent includes one or more components each selected from the group consisting of formic acid, acetic acid, gluconic acid, malic acid, citric acid, homo citric acid, succinic acid, lactic acid, malonic acid, aspartic acid, 3,4-dihydroxybenzoic acid, 2,3-dihydroxybenzoic acid, tartaric acid, salicylic acid, glutamic acid, oxalic acid, 2,3-Di mercapto-1-propane sulfonic acid, meso-2,3- di mercapto succinic acid, glycine, alanine, imino di acetic acid, EDTA (ethylene diamine tetra-acetic acid), EGTA ethylene glycol-bis(2-amino ethyl ether)-N,N,N′,N′-tetra acetic acid), EDDS (ethylene di amine-N,N′-di succinic acid), NTA (nitrilo-tri-acetic acid), DTPA (diethyl triamine penta-acetic acid), PDTA (1,3-propylene diamine penta-acetic acid), MGDA (methyl glycine diacetic acid), β-ADA (β-alanine diacetic acid), HEIDA (N-(2-hydroxyethyl)imino diacetic acid), DHEG (N,N-bis(2-hydroxyethyl)glycine), HEDTA (hydroxy ethyl-ethylene diamine tri-acetic acid), quadrol (N,N,N′,N′-tetrakis-2-hydroxyisopropyl- ethylendiamine), DTPMP (diethylene triaminopenta (methylene phosphonic acid)), EDTMP (ethylene diaminotetra(methylene phosphonic acid)), HDTMP (hexamethylene diaminotetra (methylene phosphonic acid)), ATMP (aminotrimethylene phosphonic acid), HEDP (hydroxyethane dimethylene phosphonic acid) and PBTC (2-butane phosphate 1,2,4-tricarboxylic acid), phosphoric acid, pyrophosphoric acid, and combinations thereof.

15. The producing method of claim 12 wherein said reducing agent includes one or more components each selected from the group consisting of formic acid, acetic acid, gluconic acid, malic acid, citric acid, homo citric acid, succinic acid, lactic acid, malonic acid, aspartic acid, 3,4-dihydroxybenzoic acid, 2,3-dihydroxybenzoic acid, tartaric acid, salicylic acid, glutamic acid, oxalic acid, 2,3-Di mercapto-1-propane sulfonic acid, meso-2,3- di mercapto succinic acid, glycine, alanine, imino di acetic acid, EDTA (ethylene diamine tetra-acetic acid), EGTA ethylene glycol-bis(2-amino ethyl ether)-N,N,N′,N′-tetra acetic acid), EDDS (ethylene di amine-N,N′-di succinic acid), NTA (nitrilo-tri-acetic acid), DTPA (diethyl triamine penta-acetic acid), PDTA (1,3-propylene diamine penta-acetic acid), MGDA (methyl glycine diacetic acid), β-ADA β-alanine diacetic acid), HEIDA (N-(2-hydroxyethyl)imino diacetic acid), DHEG (N,N-bis(2-hydroxyethyl)glycine), HEDTA (hydroxy ethyl-ethylene diamine tri-acetic acid), quadrol (N,N,N′,N′-tetrakis-2-hydroxyisopropyl- ethylendiamine), DTPMP (diethylene triaminopenta (methylene phosphonic acid)), EDTMP (ethylene diaminotetra(methylene phosphonic acid)), HDTMP (hexamethylene diaminotetra (methylene phosphonic acid)), ATMP (aminotrimethylene phosphonic acid), HEDP (hydroxyethane dimethylene phosphonic acid) and PBTC (2-butane phosphate 1,2,4-tricarboxylic acid), phosphoric acid, pyrophosphoric acid, and combinations thereof.

16. A method for producing a transition metal coordination compound (TMCC) that includes reacting an alkali salt of a coordination complex with a salt of a transition metal in a reaction solution which produces a first set of particles of the TMCC having a first characteristic particle size, the improvement comprises including a reacting material with said reaction solution during said reacting step which produces a second set of particles of the TMCC having a second characteristic particle size greater than said first characteristic particle size.

17. The producing method of claim 16 wherein said first characteristic particle size includes a range of 10 nm to 100 nm and wherein said second characteristic particle size includes a range of 50 nm to 500 nm.

18. The producing method of claim 16 wherein the TMCC includes a first set of performance properties when reacted without said reacting material and wherein said reacting step including said reacting material produces the TMCC with a second set of performance properties about equal to said first set of performance properties.

19. The producing method of claim 18 wherein said sets of performance properties both include electrochemical cycling performance.

20. The producing method of claim 18 wherein said first characteristic particle size includes a range of 10 nm to 100 nm and wherein said second characteristic particle size includes a range of 50 nm to 500 nm.

21. The producing method of claim 16 wherein a first volume includes said reaction solution, wherein a second volume includes a solution of said salt of said transition metal, and wherein a third volume includes a solution of said alkali salt of said coordination complex, and wherein said reacting includes adding said second volume into said first volume as said third volume is added into said first volume.

22. The producing method of claim 21 wherein said reaction solution includes an aqueous solution including said reducing agent at a temperature range between 25 C-100 C.

23. The producing method of claim 20 wherein a first volume includes said reaction solution, wherein a second volume includes a solution of said salt of said transition metal, and wherein a third volume includes a solution of said alkali salt of said coordination complex, and wherein said reacting includes adding said second volume into said first volume as said third volume is added into said first volume.

24. The producing method of claim 16 wherein said salt of said coordination complex includes one or more coordination complex salts each selected from the group consisting of an alkali salt of hexacyanoferrate, an alkali salt of hexacyanocobaltate, an alkali salt of hexacyanovanadate, an alkali salt of hexacyanotitanate, an alkali salt of hexacyanochromate and an alkali salt of hexacyanonickelate, and combinations thereof.

25. The producing method of claim 23 wherein said salt of said coordination complex includes one or more coordination complex salts each selected from the group consisting of an alkali salt of hexacyanoferrate, an alkali salt of hexacyanocobaltate, an alkali salt of hexacyanovanadate, an alkali salt of hexacyanotitanate, an alkali salt of hexacyanochromate and an alkali salt of hexacyanonickelate, and combinations thereof.

26. The producing method of claim 16 wherein said salt of said transition metal includes one or more transition metal salts each selected from the group consisting of an alkali salt of a transition metal and combinations thereof.

27. The producing method of claim 23 wherein said salt of said transition metal includes one or more transition metal salts each selected from the group consisting of an alkali salt of a transition metal and combinations thereof.

28. The producing method of claim 25 wherein said salt of said transition metal includes one or more transition metal salts each selected from the group consisting of an alkali salt of a transition metal and combinations thereof.

29. The producing method of claim 16 wherein said reducing agent includes one or more components each selected from the group consisting of formic acid, acetic acid, gluconic acid, malic acid, citric acid, homo citric acid, succinic acid, lactic acid, malonic acid, aspartic acid, 3,4-dihydroxybenzoic acid, 2,3-dihydroxybenzoic acid, tartaric acid, salicylic acid, glutamic acid, oxalic acid, 2,3-Di mercapto-1-propane sulfonic acid, meso-2,3- di mercapto succinic acid, glycine, alanine, imino di acetic acid, EDTA (ethylene diamine tetra-acetic acid), EGTA ethylene glycol-bis(2-amino ethyl ether)-N,N,N′,N′-tetra acetic acid), EDDS (ethylene di amine-N,N′-di succinic acid), NTA (nitrilo-tri-acetic acid), DTPA (diethyl triamine penta-acetic acid), PDTA (1,3-propylene diamine penta-acetic acid), MGDA (methyl glycine diacetic acid), β-ADA (β-alanine diacetic acid), HEIDA (N-(2-hydroxyethyl)imino diacetic acid), DHEG (N,N-bis(2-hydroxyethyl)glycine), HEDTA (hydroxy ethyl-ethylene diamine tri-acetic acid), quadrol (N,N,N′,N′-tetrakis-2-hydroxyisopropyl- ethylendiamine), DTPMP (diethylene triaminopenta (methylene phosphonic acid)), EDTMP (ethylene diaminotetra(methylene phosphonic acid)), HDTMP (hexamethylene diaminotetra (methylene phosphonic acid)), ATMP (aminotrimethylene phosphonic acid), HEDP (hydroxyethane dimethylene phosphonic acid) and PBTC (2-butane phosphate 1,2,4-tricarboxylic acid), phosphoric acid, pyrophosphoric acid, and combinations thereof.

30. The producing method of claim 26 wherein said reducing agent includes one or more components each selected from the group consisting of formic acid, acetic acid, gluconic acid, malic acid, citric acid, homo citric acid, succinic acid, lactic acid, malonic acid, aspartic acid, 3,4-dihydroxybenzoic acid, 2,3-dihydroxybenzoic acid, tartaric acid, salicylic acid, glutamic acid, oxalic acid, 2,3-Di mercapto-1-propane sulfonic acid, meso-2,3- di mercapto succinic acid, glycine, alanine, imino di acetic acid, EDTA (ethylene diamine tetra-acetic acid), EGTA ethylene glycol-bis(2-amino ethyl ether)-N,N,N′,N′-tetra acetic acid), EDDS (ethylene di amine-N,N′-di succinic acid), NTA (nitrilo-tri-acetic acid), DTPA (diethyl triamine penta-acetic acid), PDTA (1,3-propylene diamine penta-acetic acid), MGDA (methyl glycine diacetic acid), β-ADA (β-alanine diacetic acid), HEIDA (N-(2-hydroxyethyl)imino diacetic acid), DHEG (N,N-bis(2-hydroxyethyl)glycine), HEDTA (hydroxy ethyl-ethylene diamine tri-acetic acid), quadrol (N,N,N′,N′-tetrakis-2-hydroxyisopropyl- ethylendiamine), DTPMP (diethylene triaminopenta (methylene phosphonic acid)), EDTMP (ethylene diaminotetra(methylene phosphonic acid)), HDTMP (hexamethylene diaminotetra (methylene phosphonic acid)), ATMP (aminotrimethylene phosphonic acid), HEDP (hydroxyethane dimethylene phosphonic acid) and PBTC (2-butane phosphate 1,2,4-tricarboxylic acid), phosphoric acid, pyrophosphoric acid, and combinations thereof.

31. The producing method of claim 27 wherein said reducing agent includes one or more components each selected from the group consisting of formic acid, acetic acid, gluconic acid, malic acid, citric acid, homo citric acid, succinic acid, lactic acid, malonic acid, aspartic acid, 3,4-dihydroxybenzoic acid, 2,3-dihydroxybenzoic acid, tartaric acid, salicylic acid, glutamic acid, oxalic acid, 2,3-Di mercapto-1-propane sulfonic acid, meso-2,3- di mercapto succinic acid, glycine, alanine, imino di acetic acid, EDTA (ethylene diamine tetra-acetic acid), EGTA ethylene glycol-bis(2-amino ethyl ether)-N,N,N′,N′-tetra acetic acid), EDDS (ethylene di amine-N,N′-di succinic acid), NTA (nitrilo-tri-acetic acid), DTPA (diethyl triamine penta-acetic acid), PDTA (1,3-propylene diamine penta-acetic acid), MGDA (methyl glycine diacetic acid), β-ADA (β-alanine diacetic acid), HEIDA (N-(2-hydroxyethyl)imino diacetic acid), DHEG (N,N-bis(2-hydroxyethyl)glycine), HEDTA (hydroxy ethyl-ethylene diamine tri-acetic acid), quadrol (N,N,N′,N′-tetrakis-2-hydroxyisopropyl- ethylendiamine), DTPMP (diethylene triaminopenta (methylene phosphonic acid)), EDTMP (ethylene diaminotetra(methylene phosphonic acid)), HDTMP (hexamethylene diaminotetra (methylene phosphonic acid)), ATMP (aminotrimethylene phosphonic acid), HEDP (hydroxyethane dimethylene phosphonic acid) and PBTC (2-butane phosphate 1,2,4-tricarboxylic acid), phosphoric acid, pyrophosphoric acid, and combinations thereof.

32. The producing method of claim 28 wherein said reducing agent includes one or more components each selected from the group consisting of formic acid, acetic acid, gluconic acid, malic acid, citric acid, homo citric acid, succinic acid, lactic acid, malonic acid, aspartic acid, 3,4-dihydroxybenzoic acid, 2,3-dihydroxybenzoic acid, tartaric acid, salicylic acid, glutamic acid, oxalic acid, 2,3-Di mercapto-1-propane sulfonic acid, meso-2,3- di mercapto succinic acid, glycine, alanine, imino di acetic acid, EDTA (ethylene diamine tetra-acetic acid), EGTA ethylene glycol-bis(2-amino ethyl ether)-N,N,N′,N′-tetra acetic acid), EDDS (ethylene di amine-N,N′-di succinic acid), NTA (nitrilo-tri-acetic acid), DTPA (diethyl triamine penta-acetic acid), PDTA (1,3-propylene diamine penta-acetic acid), MGDA (methyl glycine diacetic acid), β-ADA (β-alanine diacetic acid), HEIDA (N-(2-hydroxyethyl)imino diacetic acid), DHEG (N,N-bis(2-hydroxyethyl)glycine), HEDTA (hydroxy ethyl-ethylene diamine tri-acetic acid), quadrol (N,N,N′,N′-tetrakis-2-hydroxyisopropyl- ethylendiamine), DTPMP (diethylene triaminopenta (methylene phosphonic acid)), EDTMP (ethylene diaminotetra(methylene phosphonic acid)), HDTMP (hexamethylene diaminotetra (methylene phosphonic acid)), ATMP (aminotrimethylene phosphonic acid), HEDP (hydroxyethane dimethylene phosphonic acid) and PBTC (2-butane phosphate 1,2,4-tricarboxylic acid), phosphoric acid, pyrophosphoric acid, and combinations thereof.

33. A material, comprising:
a transition metal coordination compound (TMCC) including a plurality of particles having a first particle size within a range of 50 nm-500 nm and including a first electrochemical cycling performance about equal to a second electrochemical cycling performance of said TMCC having a second particle size about one-fifth that of said first particle size.
